(19) United States
(12) Patent Application Publication
(10) Pub. No.: US 2003/0084577 A1
(43) Pub. Date: May 8, 2003

(54) Cutting implement comprising a multi-element mineral

(76) Inventor: Kazutoshi Kaizuka, Fukuoka (JP)

Correspondence Address: Dave B. Koo, Esq., Squire, Sanders & Dempsey L.L.P., 14th Floor, 801 S. Figueroa Street, Los Angeles, CA, 90017-5554, US

(21) Appl. No.: 10/039,844

(22) Filed: Nov. 6, 2001

(51) Int. Cl. B26B 9/00; B26B 21/58

(52) U.S. Cl. 30/350; 30/346.54

(57) ABSTRACT

A cutting implement using a multi-element mineral to increase the sharpness and durability while also providing therapeutic effects to individuals coming into physical contact with the cutting implement. When used in hairdressing razors and scissors, the anions in the multi-element mineral should produce a mineralizing effect in the individual whose hair is being cut that activates proteins and promotes healthy hair and skin.

### BACKGROUND OF THE INVENTION

1. Field of the Invention

The present invention relates to a cutting implement having a multi-element mineral which improves the effectiveness of cutting implements used in hairdressing razors (for shaping and cutting hair) and hairdressing scissors for use in barber shops and beauty salons. The invention also has application in surgical scalpels, as well as other cutting implements such as kitchen-knives, knives, and the inner and/or outer blades of electric razors.

2. General Background and State of the Art

Hairdressing razors, scissors and surgical scalpels, as well as cutting implements such as kitchen-knives and knives, generally include a blade mounted at the end of a grip or, in replaceable-blade cutting implements, a replaceable blade removably mounted in a holder at the end of a grip. When these cutting implements are used, the grip is held in a hand, and the blade is used to cut.

Hairdressing scissors may be formed by welding respective handle portions to blades to form a pair of scissor members pivotally joined at the boundary between the blade and the handle, which allows the blade and the handle to be cast separately using lost-wax casting methods. To use hairdressing scissors, digits are inserted into finger holes, the two scissor members are opened and closed, and hair caught between the blades is cut.

When the cutting devices are utilized in accordance with their intended uses, the blade is inevitably worn or abraded. Because hairdressing razors experience a significant degree of wear, they become blunt after a short period of use, which limits their useful life. Cutting implements that come into contact with human skin or which are used to cut animal meat products face a special problem. Oils from human skin or animal products adhere to the surface of the cutting implement and further contribute to the rapid wear and blunting.

Cutting implements on the market today can cause injury to the user even from proper but repeated use, especially after the blade becomes blunt. Cutting operations in beauty salons and barbershops involve opening and closing the two scissor members repeatedly over a small distance. As a result, a great strain is placed on the fingers of hairdressers and barbers who work for several hours every day. The strain in the fingers can lead to a build-up of fatigue in thee arms, often causing occupational illnesses such as tendinitis and arthritis. Moreover, a high cost results from having to replace rapidly blunting cutting implements. Accordingly, it would be beneficial to develop a blade in various cutting implements that not only lasts longer and cuts better than other blades but also is therapeutic to the user.

### SUMMARY OF THE INVENTION

The present invention is directed to the incorporation of multi-element minerals in various cutting implements. This incorporation of multi-element minerals increases the durational and functional life of the implement. Further, the presence of multi-element minerals in the cutting device benefits both the person using the device as well as the person on whom the device is being used. Thus, the present invention includes several embodiments that have multi-element minerals as part of their composition.

It is well known in the prior art that multi-element minerals release anions into the environment. It has now been found that these anions improve hardness, sharpness and durability of a cutting blade. For example, oils from human hair or skin as well as those from animal meat will generally adhere to the blade, and the oils are difficult to remove. These oils contribute to faster blunting. However, because of the effect anions have on oils, oils do not adhere as well on cutting implements with multi-element minerals, and the oil is also easier to wipe off.

Furthermore, electromagnetic waves (feeble energy) with wavelengths of 4 to 14 μm, which are emitted from the multi-element minerals, can transform the surrounding of an atomic nucleus such that the atom and the material reach an excited state. This transformation accordingly causes a cutting and shortening of the polymerization of water clusters, decreasing the volume of water and increasing the specific gravity. Moreover, sufficient attachment of free water onto the external cell membranes of animals and plants occurs from the transformation. As a result, penetration of water and Ca²⁺ is promoted within the cells, activating several functions of the cells. These electromagnetic waves are applied to the hair and scalp when the cutting implement comes into contact with the hair or scalp; water within the hair and scalp will thus be mineralized, and protein in the hair and scalp will be activated, keeping the hair healthy and shiny. As an additional benefit, the combined actions of the anions and of electromagnetic waves promote blood circulation in fingers holding the cutting implement. This relieves fatigue in fingers and can prevent the occurrence of occupational illnesses of barbers and hairdressers such as tendinitis and arthritis.

The nature of some instruments like a shaping razor, a cutting razor, a surgical scalpel, or an electric razor requires a replaceable blade; other instruments such as knives and scissors require ail irremovably mounted blade due to their inherent design and functional pararmeters. Accordingly, a multi-element mineral can form a component or the entire composition of the handle, grip and blade of any such cutting implement.

The above described and many other features and attendant advantages of the present invention will become apparent from a consideration of the following detailed description in conjunction with the accompanying drawings.

### BRIEF DESCRIPTION OF THE DRAWINGS

A detailed description of the invention will be made with reference to the accompanying drawings wherein:

FIG. 1 is a side view showing a shaping razor for hairdressing.

FIG. 2 is a side view showing a cutting razor for hairdressing.

FIG. 3 is a perspective view showing a surgical scalpel.

FIG. 4 is a side view showing a kitchen-knife.

FIG. 5 is a side view showing a knife.

FIG. 6 is a perspective view showing an electric razor.

FIG. 7 is a plane view showing a pair of scissors.

### DETAILED DESCRIPTION OF THE PREFERRED EMBODIMENTS

As used herein, the term multi-element mineral includes silicon-based minerals such as granite, perlite, pitchstone, and tourmaline. These minerals radiate electromagnetic waves (feeble energy) and release anions. If these minerals are added to stainless steel or Stellite steel, and the like, the hardness and abrasion resistance of the steel is increased, and the sharpness and durability of the stainless or Stellite steel can be improved. In addition, the action of the anions produces a water clustering effect and activates proteins in facial hair and facial skin, allowing for promotion of the health of hair and skin.

To prepare multi-element minerals for use in the instant invention, the minerals, such as perlite, are milled into a powder preferably with the size of about 0.5 to 3.0 microns using a ball mill. Blending two or more such minerals with the proper blending ratio forms the preferable multi-element mineral powder. The powder can be used to mix into the plating liquid or it can be mixed with the substrate at the time of casting. Alternatively, it can also be used after it is mixed with water, whether heated or pressurized, so that the clear liquid part of the water dries into a powder by vacuum-freeze drying or by spray drying methods.

The following table shows the content of perlite:

TABLE 1

| | |
|---|---|
| Siliccn dioxide (SiO₂) | 71.94% |
| Aluminum oxide (Al₂O₃) | 14.94 |
| Ferrous oxide (Fe₂O₃) | 2.54% |
| Magnesium oxide (MgO) | 0.44% |
| Calcium oxide (CaO) | 2.47% |
| Alkali oxide (K₂O + Na₂O) | 6.87% |
| Manganese oxide (MnO) | 0.03% |
| Phosphoric anhydride (P₂O₅) | 0.14% |
| Agnition loss | 3.43% |
| Drying loss (at 110° C.) | 0.07% |
| Other, titanium | Trace |

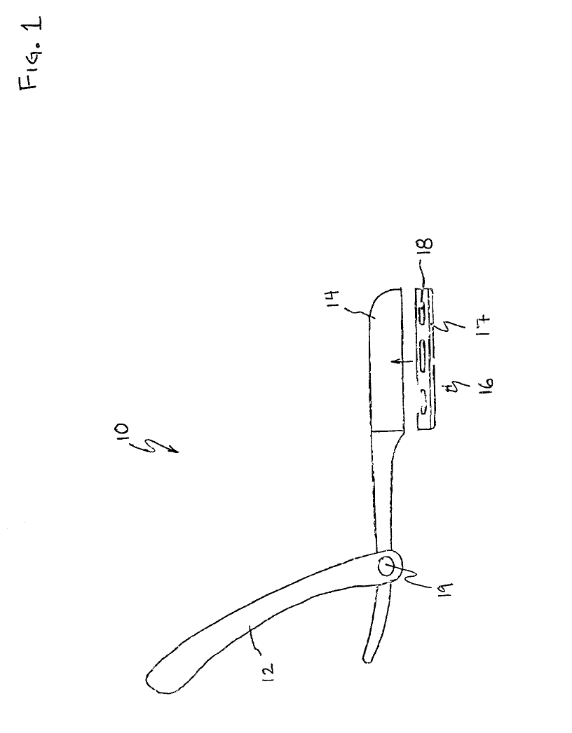

Shown in FIG. 1 is a shaping razor 10 which is used for shaving, according to one embodiment of the present invention. An holder 14 is rotatably mounted by way of an axle 19 at the end of a grip 12. The blade 16 includes a cutting edge 17 and a plurality of mounting slots 18, which are used to removably mount the blade 16 into the holder 14. In one embodiment, when the blade 16 is manufactured, a mixture of powdered perlite and tourmaline, approximately 0.5 to 1.0% by volume, is mixed with molten steel. In this manner, a multi-element mineral component will be incorporated uniformly throughout he blade 16. Optionally, the holder 14 of the shaping razor 10 may have a multi-element mineral component ranging from 0.5 to 50.0% by volume.

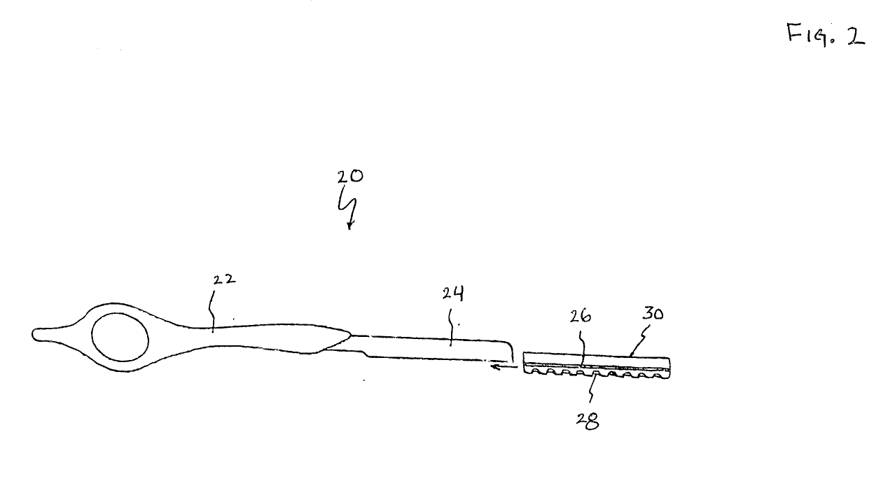

FIG. 2 illustrates another embodiment of the present invention. A cutting razor 20 used for hairdressing includes a grip 22 and a holder 24. The holder 24 is mounted at the end of the grip 22, and a blade 26 is removably mounted in this holder 24. The blade 26 has a cutting edge 28 and is placed inside of a blade mounting member 30. The blade mounting member 30 is adapted to slide in and out of the holder 24 allowing for easy replacement of the blade 26. In one embodiment, mixing approximately 0.5 to 1.0% by volume perlite powder wish steel forms the blade 26. In another embodiment, the holder 24 and the blade mounting member 30 also have a multi-element mineral composition ranging from 0.to 50.0% by volume. The present invention includes T-shaped, folding or rigid formatted razors.

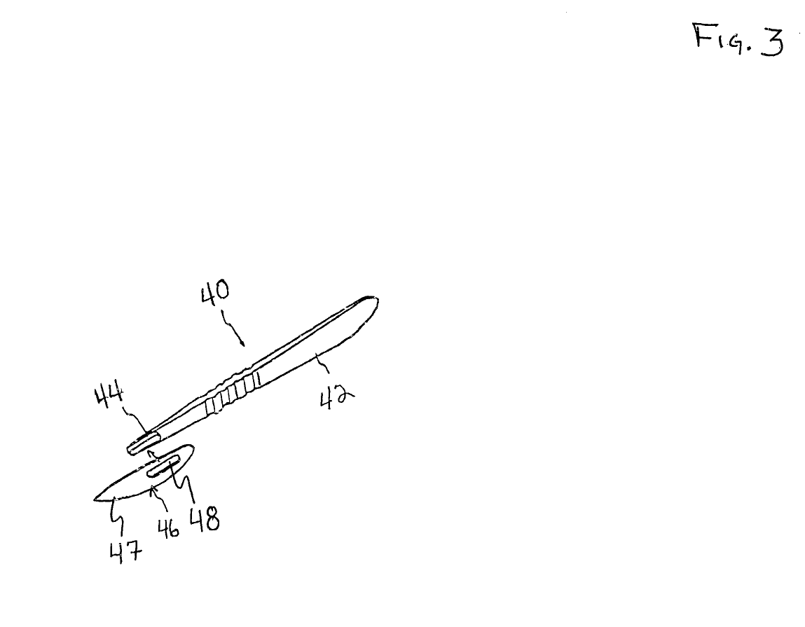

As depicted in FIG. 3, a surgical scalpel 40, another embodiment of the present invention, has a holder 44 formed at the end of a stainless steel grip 42. The holder 44 is adapted to mount and hold a replaceable blade 46 with a mounting slot 48 and a cutting edge 47. Preferably, in manufacture of the blade 46 with a multi-element mineral component, a mixture of powdered perlite and tourmaline, approximately 0.5 to 1.0% by volume, is mixed with molten steel. In this manner, the multi-element mineral component will be incorporated uniformly throughout the blade 46. The surgical scalpel 40 may optionally include a multi-element mineral component in the grip 42 and the holder 44 ranging from 0.5 to 50.0% by volume.

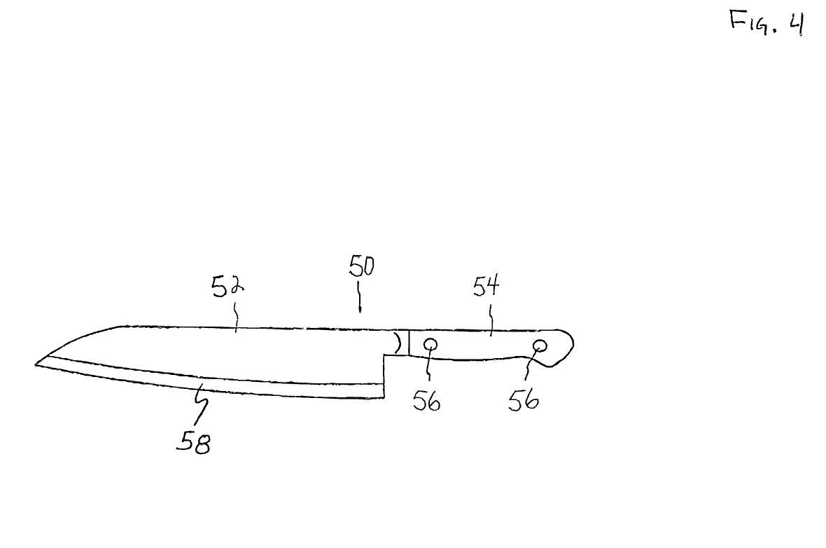

FIG. 4 is a side view of a kitchen-knife 50, according to another embodiment of the present invention. A blade 52 with a cutting edge 58 is solidly mounted at the end of a grip 54 by means of a retainer 56. In one embodiment, admixing a mixture of approximately 2.0 to 3.0% by volume of powdered perlite and tourmaline with stainless or Stellite steel forms the blade 52. The term kitchen-knife includes all knives used in cooking.

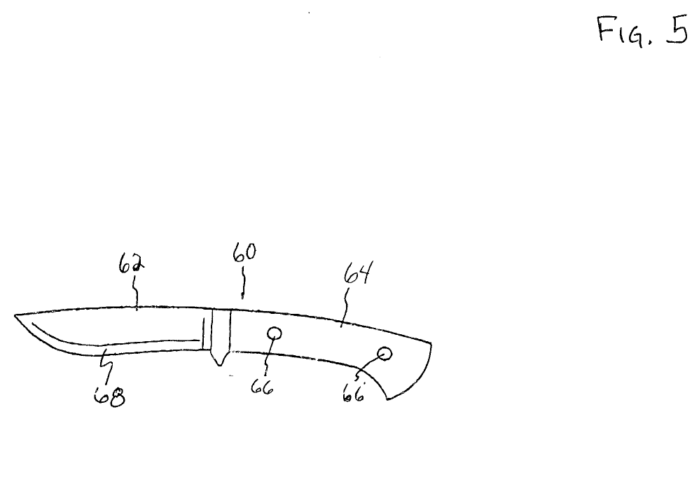

Yet another embodiment of the present invention as shown in FIG. 5 is a knife 60. A blade 62 with a cutting edge 68 is solidly mounted at the end of a grip 64 by means of a retainer 66. In one embodiment, admixing a mixture of approximately 2.0 to 3.0% by volume of powdered perlite and tourmaline with stainless or Stellite steel forms the blade 62. The term knife includes all knives used for severing and cutting, such as those used for working, cooking, eating, and those used for outdoor activities such as survival knives.

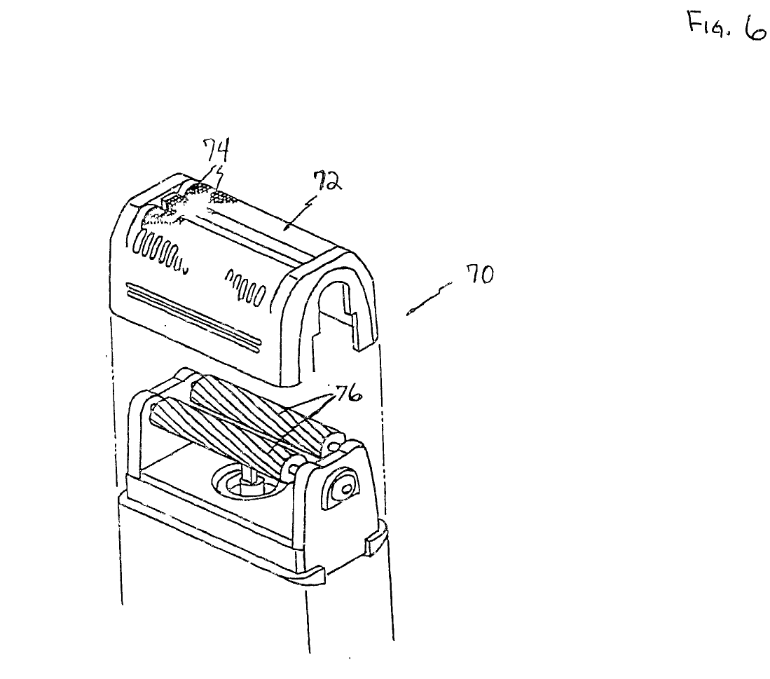

As seen in FIG. 6, another embodiment of the present invention is an electric razor 70. The electric razor 70 has a set of inner blades 76, preferably rotary, and an outer blade 72, which has a plurality of holes 74. Hair enters through the holes 74 and is cut by the inner blades 76. In one embodiment, a mixture of approximately 2.0 to 3.0% by volume of powdered perlite and tourmaline forms a component for either the outer blade 72 and or the inner blades 76. The term blade includes both the outer blade 72 and the inner blades 76. The electric razor 70 may be of revolving type, oscillating type, or rotary type, and it is possible that only one of the outer or inner blades comprise a multi-element mineral component.

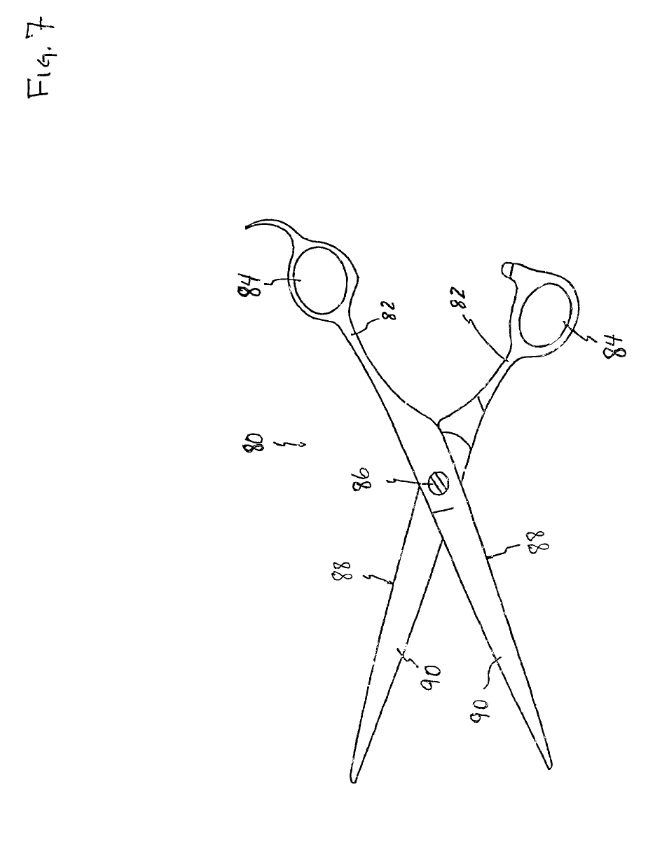

Shown in FIG. 7 is a pair of hairdressing scissors 80. The scissors 80 are formed by pivotally joining a pair of scissor members 88 with a screw-pin 86 at the boundary between blades 90 and handles 82. Finger holes 84 are formed in the handles 82. Each of the scissor members 88 is formed by separately casting the blade 90 in Stellite steel and the handle 82 in stainless steel using lost-wax casting methods. The blade 90 and the handle 82 are then preferably welded together. The handle 82 and the blade 90 are cast using the same percentage of powdered perlite and tourmaline, namely a powdered mixture of approximately 2.0 to 3.0% by volume with molten stainless or Stellite steel. To form the handle 82, the powdered perlite and tourmaline is mixed with molten stainless steel, whereas to form the blade 90, the powdered mixture is added to molten Stellite steel. The blade 90 is sharpened according to standard industry methods. As the blade 90 substrate or plating has a multi-element mineral component, the hardness of the blade 90 is increased as a result, providing excellent abrasion resistance and allowing for improvements in the durability of the sharpness of the blade.

Modes of embodiment of the present invention have been described above, but the specific constitution of the invention is not limited to these modes of embodiment. For example, in addition to those shown in the above modes of embodiment, cutting implements that use replaceable blades may be utility cutters wherein the replaceable blades have a multi-element mineral component. Further, in one mode of embodiment, cutting scissors are shown wherein the blades of both of the scissor members are straight blades. The constitution of the present invention may also be applied so that the blade of one of the scissor members is a straight blade and the blade of the other scissor member is a comb-blade to form comb-scissors.

In the above modes of embodiment, cases were shown wherein the handle and the blade both had a multi-element mineral component. Other cases may be such that only the handle or only the blade has a multi-element mineral component. The multi-element mineral can form part of the plating layer or the substrate of either the handle or blade or grip. If only the blade has a multi-element mineral component, a multi-element mineral component may be incorporated in the handle plating layer when the surface of the handle is plated. Steel is an alloy of cobalt, chromium, tungsten, iron, and the like, wherein the percentage composition of each constituent can be changed to adjust the grain, hardness, and other qualities of the mold. Therefore, products made of Stellite steel do not require such processes as tempering. In several modes of embodiment, the blade is made out of Stellite. Also, Stellite steel nay also be used for the handle.

Having thus described different embodiments of the invention, other variations and embodiments that do not depart from the spirit of the invention will become readily apparent to those skilled in the art. The scope of the present invention is thus not limited to any one particular embodiment, but is instead set forth in the appended claims and the legal equivalents thereof.

what is claimed is:

1. A cutting implement comprising:
a holder; and
a blade, said blade mounted in said holder, wherein said blade includes multi-element minerals.

2. The cutting implement of claim 1, wherein said blade is removably mounted on said holder.

3. The cutting implement of claim 2, wherein said cutting implement is configured as a shaping razor, a cutting razor, or a surgical scalpel.

4. The cutting implement of claim 1, wherein said blade is solidly mounted on said holder.

5. The cutting implement of claim 4, wherein said cutting implement is configured as a shaping razor, a cutting razor, a surgical scalpel, a kitchen-knife, or a knife.

6. The cutting implement according to claim 1, further comprising a pair of scissor members.

7. The cutting implement according to claim 1, wherein said multi-element minerals comprise silicon based minerals.

8. The cutting implement according to claim 7, wherein said multi-element minerals comprise granite, perlite, pitchstone, and tourmaline.

9. The cutting implement according to claim 8, wherein said perlite comprises of silicon dioxide, aluminum oxide, ferrous oxide, magnesium oxide, calcium oxide, alkali oxide, manganese oxide and phosphoric anhydride.

10. The cutting implement according to according to claim 1, wherein said multi-element mineral is mixed with a steel and comprises 0.5% to 50.0% by volume.

11. The cutting implement according to claim 1, wherein the multi-element mineral is mixed with a steel and comprises 2.0% to 3.0% by volume

12. A cutting implement, wherein said cutting implement is an electric razor having at least one set of inner and outer blades, wherein at least one blade includes multi-element minerals.

13. A method of producing a water clustering effect with electromagnetic waves to mineralize the water components of hair and skin in an individual who comes into contact with a cutting implement comprising:
providing a cutting implement having a holder and a blade mounted in said holder, said cutting implement formed from a material including a multi-element mineral component.

14. A method of providing therapeutic anions to aid prevention of tendinitis or arthritis in an individual who must utilize a handle held cutting implement comprising:
providing a cutting implement having a holder and a blade mounted in said holder, said cutting implement formed from a material including a multi-element mineral component.
